(19) United States
(12) Patent Application Publication
(10) Pub. No.: US 2026/0119300 A1
(43) Pub. Date: Apr. 30, 2026

(54) EFFICIENT ERROR CHAIN LOGGING IN A MULTI-CORE, ASYNCHRONOUS EXECUTION ENVIRONMENT

(71) Applicant: Microsoft Technology Licensing, LLC, REDMOND, WA (US)

(72) Inventor: Garret BUBAN, Snoqualmie, WA (US)

(21) Appl. No.: 18/927,556

(22) Filed: Oct. 25, 2024

(51) Int. Cl. G06F 11/07

(52) U.S. Cl. CPC G06F 11/0787; G06F 11/0724; G06F 11/079

(57) ABSTRACT

Methods, apparatuses, and products for efficient error chain logging in a multi-core, asynchronous execution environment, including: generating, in response to detecting an error at an error originating function in a chain of functions, a chain of error records that includes an error record for the error originating function and error records for each function at a higher-level than the error originating function, including: storing, in each error record other than the error record for the error originating function, error information that includes an identification of an error record for an immediately-lower level function; and storing each error record in a data structure for a core that is executing at least a portion of the chain of functions, wherein each core maintains a distinct data structure for storing error records.

### BACKGROUND

Error logging is used to track errors detected in a computing system. Each error log entry may include information describing a particular error, such as an error code indicating a type of error that was detected, the location within a software application that a particular error occurred, and the like. This information may be useful in identifying, triaging, or fixing bugs, identifying vulnerabilities in software, or otherwise improving the quality of software.

Software applications often rely on chains of functions, whereby one function calls another function, which may then call another function, and so forth. An error occurring in a particular function can cause that function to return error information to its calling function. In a chain of functions this may cause errors to propagate up the chain of functions, with each function providing some error information describing its respective errors. A top-level function in the chain may then cause an error log to be written based on its received error information. As each function is returning its own error information describing its own detected error, error information from lower-level functions may be lost by the time it reaches higher levels. This may cause the resulting error log to lack potentially valuable information.

### SUMMARY

According to embodiments of the present disclosure, various methods, apparatus, and products for efficient error chain logging in a multi-core, asynchronous execution environment are described herein. In some aspects, efficient error chain logging in a multi-core, asynchronous execution environment includes: generating, in response to detecting an error at an error originating function in a chain of functions, a chain of error records that includes an error record for the error originating function and error records for each function at a higher-level than the error originating function, including: storing, in each error record other than the error record for the error originating function, error information that includes an identification of an error record for an immediately-lower level function; and storing each error record in a data structure for a core that is executing at least a portion of the chain of functions, wherein each core maintains a distinct data structure for storing error records. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a diagram depicting an error occurring in a chain of functions in accordance with some embodiments of the present disclosure.

FIG. 2 sets forth a diagram of an example system for efficient error chain logging in a multi-core, asynchronous execution environment in accordance with some embodiments of the present disclosure.

FIG. 3 sets forth a diagram of example error information for efficient error chain logging in a multi-core, asynchronous execution environment in accordance with some embodiments.

FIG. 4 sets forth a flow chart illustrating an example method of efficient error chain logging in a multi-core, asynchronous execution environment in accordance with some embodiments.

FIG. 5 sets forth a flow chart illustrating an additional example method of efficient error chain logging in a multi-core, asynchronous execution environment in accordance with some embodiments.

FIG. 6 sets forth a flow chart illustrating an additional example method of efficient error chain logging in a multi-core, asynchronous execution environment in accordance with some embodiments.

FIG. 7 sets forth a flow chart illustrating an additional example method of efficient error chain logging in a multi-core, asynchronous execution environment in accordance with some embodiments.

FIG. 8 sets forth a flow chart illustrating an additional example method of efficient error chain logging in a multi-core, asynchronous execution environment in accordance with some embodiments.

FIG. 9 sets forth a flow chart illustrating an additional example method of efficient error chain logging in a multi-core, asynchronous execution environment in accordance with some embodiments.

FIG. 10 sets forth a flow chart illustrating an additional example method of efficient error chain logging in a multi-core, asynchronous execution environment in accordance with some embodiments.

FIG. 11 illustrates an exemplary computing device that may be specifically configured to perform one or more of the processes described in the present disclosure.

### DESCRIPTION OF EMBODIMENTS

A function in a software program may call other functions in order to complete its operations. For example, a higher-level first function may call a second, lower-level function, which itself may call a third, even lower-level function, and so forth. As a result, a chain of function calls must be completed for the first function to complete. The use of these chains of functions may introduce complications when performing error logging.

Error logging is used to output information describing a detected error, which may be later used for troubleshooting, software debugging, and the like. When an error is detected while a function is being executed, that function may return error information such as an error code for the particular error that was detected, a location in the code defining the function where the error occurred, or other information. When an error occurs in a chain of functions, a lower-level function that experienced an error may return this error information to a higher-level function that called it, causing an error in that higher-level function to be detected. This higher-level function may then return error information to an even higher-level function that called it, causing errors to be detected and error information sent up the chain of functions. Stated differently, a higher-level function may return some error information even though the execution of that higher-level function itself did not cause an error to be generated.

Existing implementations for performing error logging present various drawbacks when used with chains of functions. Some implementations have each function that experiences an error output and store its own error information. In order to troubleshoot an error that occurred in a chain of functions, disparate error information written by the different functions in the chain must be parsed and correlated, requiring additional time and resources. Some other implementations have functions returning small amounts of error information when an error is detected, such as an error code and a location in code where the error was detected in that particular function. As a limited amount of error information is passed from one function to another, information from lower-level functions may be lost. For example, a function may receive error information from a lower-level function which causes an error in the function itself. If the function only returns details about its own error, it may omit information about the original lower-level error. This loss of information can make it difficult to trace the actual source of the error. Moreover, error codes may change across functions, causing lower-level error codes to be lost before reaching higher-level functions.

Further implementations have functions returning more detailed amounts of error information up the chain of functions, with each function appending their error information onto the error information received from a lower-level function. Though this prevents error information loss, this causes the amount of error information passed up the chain of functions to grow over time, increasing the computational overhead required to pass error information between each function. This may cause performance degradation when used in systems that have a high frequency of operations.

To address these shortcomings, the approaches set forth herein rely on storing a record in a data structure that describes a detected error. As errors propagate up a chain of functions, this causes records to be written for each function in the chain of functions describing their detected error. This may include, for example, implementing different data structures exclusive to each core of the system such that a given core will store records in its corresponding data structure, eliminating the need for locks on the data structure before writing. These data structures may be implemented as circular data structures that are of a fixed size, eliminating the need to dynamically allocate and reallocate memory to store them. Rather than returning the error information itself, a function that experiences an error may instead return an identifier of the stored record to the higher-level function. Each record may include detailed error information, including an error code, a location in the function code where the error occurred, or other information as can be appreciated. If the given function has detected an error due to an error in a lower-level function, that lower-level function would have returned, to the given function, an identifier for the record stored by the lower-level function. Accordingly, the record stored by the given function may also include the identifier of the record stored by the lower-level function. This effectively forms a chain of error records with each error record referencing and/or referenced by another error record in the chain.

An error log may then be created by accessing the highest-level error record and including its information in the error log. That accessed record will also include an identifier for another, lower-level record, allowing for the chain of error records to be traversed down to the error record for the lowest-level function that detected the root error. Therefore, the error log may include detailed error information across the chain of functions without the performance degradation caused by the implementations described above that rely on passing increasing amounts of data between functions. This also prevents information loss that occurs in implementations described above that only pass small amounts of information between functions. Moreover, as the error records are stored as a chain of related error records, this allows for the information to be included in the error log to be accessed without computationally expensive data parsing and correlation. Thus, these approaches allow for the creation of detailed and more informative error logs for troubleshooting without performance degradation.

Engineers involved in software development and testing can represent meaningful expenses to companies, making effective use of their time essential. By providing more detailed and informative error logs, engineers may more easily and quickly triage and address software errors, saving both development time and associated costs. As such, providing business organizations with the error logging and tracking capabilities described herein can deliver tremendous value to the business organization, by increasing the efficiency of their development teams. Moreover, the embodiments described here can help software support teams to reduce the mean time to resolve (MTTR) software errors due to having more detailed information about the error, reducing potential downtime and improving the overall customer experience.

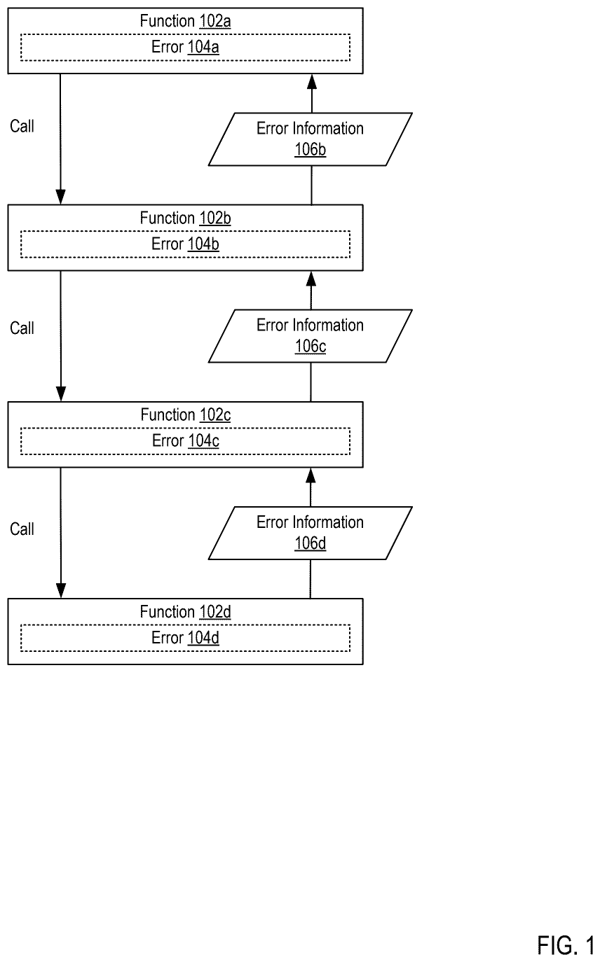

As an explanatory aid, FIG. 1 sets forth a diagram depicting an error occurring in a chain of functions in accordance with some embodiments of the present disclosure. As described herein, a function (e.g., a method) is a block of code defined to perform some specific task. A given function may include a call to another function such that the other function must complete its execution, potentially returning some value to the given function, in order for the given function to complete its execution. Here, function 102a calls function 102b which then calls function 102c that in turn calls function 102d. In order for function 102a to finish executing, the functions 102b-d must each complete their executions. Thus, functions 102a-d form a chain of functions.

In FIG. 1, if an error 104d occurs during the execution of function 102d, instead of returning a value or signaling that it has successfully executed, function 102d returns error information 106d describing the error 104d to function 102c. Since function 102c requires the successful execution of function 102d, function 102c experiences an error 104c. Function 102c therefore returns error information 106c describing the error 104c to the function 102b. This similarly causes an error 104b in function 102b, such that function 102b returns error information 106b to function 102a. As a result, function 102a generates error 104a. Function 102a may perform various actions in response to receiving the error information 106b. In some embodiments, the function 102a may consume and process the error information, including generating and/or storing log data describing the error 104a. In some embodiments, the function 102a may generate its own error information describing the error 104a and provide that error information to some other process or service. In some embodiments, the function 102a may implement some error handling functionality to complete its execution based on the detected error 104a.

Log data that is generated based on some error information (e.g., error information 106b-d) may be useful in diagnosing, triaging, and/or troubleshooting error-causing bugs. The particular approach regarding how error information 106b-d is returned and ultimately turned into log data may affect the usefulness of this log data. In some approaches, error information 106b-d may include a comparatively small amount of information (e.g., encoded in a 32- or 64-bit returned value). For example, the error information 106b-d may include an error code, which can be a predefined value corresponding to an enumeration or listing errors. Though this requires low performance overhead due to passing a small amount of information, some amount of information may be lost as error information 106b-d passes through the chain of functions. For example, the error code describing the error 104d and included in error information 106d may differ from the error code describing the error 104c included in the error information 106c.

Continuing with this example, assume that function 102c is configured to write object data. Assume that function 102c calls function 102d to issue an input/output (I/O) operation as part of its efforts to write object data. If function 102d experiences an error 104d for a cyclic redundancy check (CRC) mismatch when attempting to issue the I/O operation, error information 106d that includes an error code for a CRC mismatch may be returned back to function 102c.

This can cause function 102c to experience an error 104c for failing to write the object data, and function 102c may therefore return error information 106c that includes an error code for an object write failure. Here, function 102b is only informed that the function 102c experienced an object write failure, but function 102b is unaware of the underlying cause for the object write failure (e.g., the CRC mismatch in function 102d). Thus, potentially useful information is lost as error information 106b-d passes up the chain of functions.

In other implementations, each function in a chain of functions may generate more detailed error information that includes data beyond an error code. For example, each function may generate information describing a line in code where an error occurred, the name of a function that experienced an error, and the like. In some implementations, each function may store this error information as log data. Although this results in more detailed error information, accessing log data related to a particular chain of functions may require correlation across multiple disparate portions of log data. In other implementations, each function may append its own error information onto error information received from a lower-level function. For example, to generate error information 106c, function 102c may append information describing error 104c to error information 106d received from function 102d. Although this results in more detailed error information 106b-d and prevents loss of information up the chain of functions, these approaches require considerably more overhead in passing the increasingly growing error information 106b-d. Though this may not result in significant performance degradation in higher-level programming languages using comparatively fewer function calls, these approaches may be less useful in lower-level programming languages with a high frequency of function calls due to the resulting performance degradation.

To address these concerns, as will be described in further detail below, each function 102a-d in the chain of functions may store an error record describing their respective errors 104a-d in a data structure. For example, in some embodiments, each core of a multi-core system may be allocated its own data structure for storing error records that were generated when the associated core was executing some function. Because each core is only writing error records to its corresponding data structure, there is no need to prevent other cores from writing to their corresponding data structure. This allows for error records to be written without locking the data structure. Moreover, particular approaches for storing error records using memory barriers may further allow for error records to be written without locking the data structure should a read operation occur that targets the index of the data structure into which the error record is written.

Functions other than the highest-level function in a chain of functions may then return, to the next-highest level function (i.e., the function that is immediately higher up in the chain of functions), error information 106b-d that includes an identifier for their stored error record. This allows for more detailed information to be preserved in an error record for later use while only passing a comparatively small amount of error information 106b-d up the chain of functions. When generating an error record, functions other than a lowest-level function of the chain of functions (e.g., the functions 102a-c) may include, in their error record, the error record identifier received from the function that is immediately lower in the chain of functions. Thus, each error record other than the error record generated by the lowest-level function will include a reference to another error record, thereby forming a chain of error records terminating at the error record generated by the lowest-level function. Log data may then be generated by traversing the chain of error records, as will be described in greater detail herein.

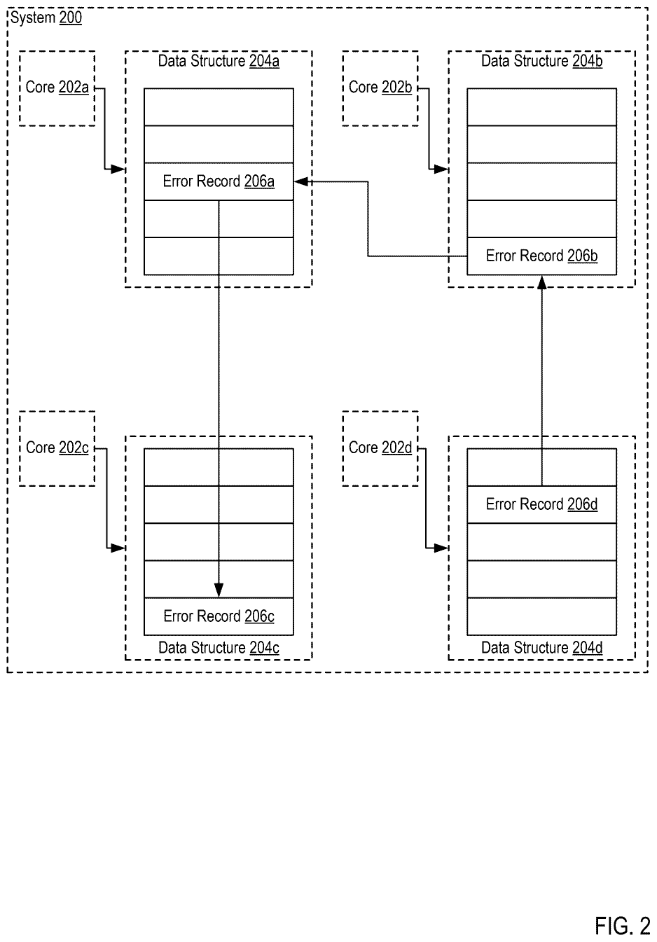

As an additional explanatory aid, FIG. 2 sets forth a diagram of an example system 200 for efficient error chain logging in a multi-core, asynchronous execution environment in accordance with some embodiments of the present disclosure. The example system 200 includes multiple cores 202a,b,c,d. Each core 202a-d is allocated (e.g., at system initialization or in response to another event) a corresponding data structure 204a,b,c,d in memory such as random-access memory (RAM). In some embodiments, the data structures 204a-d may be fixed-size data structures 204a-d that are allocated to each store a fixed number of error records 206a,b,c,d. In such embodiments, the use of fixed-size data structures 204a-d eliminates the need for allocating additional memory to data structures 204a-d as error records 206a-d are added. In embodiments where the data structures 204a-d are fixed-size, there is a possibility of an error record 206a-d being stored into a full data structure 204a-d having no available entries. Accordingly, in some embodiments, the data structures 204a-d may be implemented as circular data structures 204a-d. In a circular data structure 204a-d, error records 206a-d are written to an incrementing index value beginning at some initial index value. Once an error record 206a-d is written to the last index of the data structure 204a-d, the index value is reset, and error records 206a-d are written beginning from the initial index value. Readers will appreciate that because there are a set number of index values that reset, rather than grow indefinitely, the data structure is of a fixed size.

Consider an example in which a circular data structure is embodied as an array with N elements. In such an example, a first error record may be written to the first element in the array, a second error record may be written to a second element in the array, and so on. When the N+1 error record is written, however, an additional element is not allocated in the array. Instead, an existing element in the array may be overwritten. For example, the N+1 error record may be stored by overwriting the first error record that was written to the first element of the N element array.

Readers will appreciate that this example is used for simplicity of explanation and is not necessarily intended to explain how error records are written to a circular data structure in the embodiments of the present disclosure. This example does, however, illustrate how a circular data structure can be fixed size, as the data structure would never grow beyond N elements in size. By initially allocating enough memory to store N error records, additional memory would not need to be allocated regardless of how many error records were written to the circular data structure. Error records may be overwritten, however, due to the fixed-sized, circular nature of the data structure.

In the example system 200, assume a chain of functions that includes functions W, X, Y, and Z, with function W being the highest-level function and function Z being the lowest level function. Further assume that an error occurs in function Z. In response to this error, assume that core 202c writes an error record 206c to its corresponding data structure 204c. For example, in some embodiments, functionality for storing an error record 206a-d may be implemented using one or more defined macros included in a library or as part of source code of a program that includes chain of functions.

Function Z may then return error information that includes an identifier for the error record 206c to function Y, which is the next-highest-level function in the chain of functions. This error record identifier may include, for example, an identifier of the core 202c and/or the data structure 204c, an index in data structure 204c where error record 206c is stored, an instance count for error record 206c, and potentially other information. Receiving this error information may cause an error in function Y, thereby causing core 202a to write error record 206a to its corresponding data structure 204a, where error record 206a includes an identifier for error record 206c.

Function Y then returns error information that includes an identifier for error record 206a to function X. This causes an error in function X. In response, core 202b writes error record 206b to data structure 204b, where error record 206b includes the identifier for record 206a. Function X can subsequently return error information that includes an identifier for error record 206b to function W, thereby causing an error in function W. In response, core 202d may write an error record 206d to data structure 204d, where error record 206d includes the identifier for error record 206b. As function W is the highest-level function of the chain of functions, function W may perform error handling and/or log generation, provide its own error information to a consumer of error information for processing or log generation, and the like.

Readers will appreciate that, as error information is returned up the chain of functions and error records 206a-d are written, the particular error detected by any given function may differ from lower and/or higher-level functions in the chain of functions. Accordingly, in some embodiments, where macros are used to store an error record 206a-d, one or more macros may also be used to change the error code stored in a given error record 206a-n to a value different than the error code returned to the particular function.

Here, a chain of error records is formed from the error record 206d to the error record 206c. Accordingly, log data may be generated by traversing this chain of functions. To traverse this chain of functions, the error record 206d may be accessed from the data structure 204d. The identifier for the error record 206b may be accessed from the error record 206d and used to access the error record 206b from the data structure 204b. The error records 206a,c may then be similarly accessed using their identifiers stored in the error records 206b,a. Log data may then be generated that includes or is based on the information stored in the error records 206a-d. In some embodiments, traversing a chain of error records may be implemented by one or more macros that accepts, as input, an identifier for a highest-level error record of a chain of error records, or by another approach.

The particular data points included in an error record 206a-d may vary according to particular design and engineering considerations. In some embodiments, a particular error record 206a-d describing a particular error in a particular function may include, for example, an error code for the particular error, error information returned to the particular function (e.g., by a lower-level function), a timestamp for the particular error, a function name for the particular function, a source code file name that includes the particular function, a source code line number where the particular error occurred, and/or other information. In embodiments where the error record includes error information returned to the particular function, this error information may include an error record identifier from the lower-level function, an error code from the lower-level function, and/or other error information as can be appreciated.

In embodiments where the data structures 204a-d are fixed size, circular data structures 204a-d, there is a possibility that an error record 206a-d may be overwritten by another error record 206a-d. An attempt to read an error record 206a-d that has been overwritten may result in reading incorrect or inapplicable data. Accordingly, in some embodiments, each error record 206a-d may also include an instance count. An instance count is a value reflecting the number of times that an error record 206a-d has been written to a particular index in a data structure 204a-d. For example, assume that a new error record 206a-d is to be written to an index of a data structure 204a-d already storing an error record 206a-d with an instance count of four. The new error record 206a-d may be written to the data structure 204a-d with an instance count of five.

The instance count of an error record 206a-d may then be included in its error record identifier that may be referenced by other error records 206a-d and included in error information passed up the chain of functions. The error record identifier may also include other information that may be used to read and/or reference the error record 206a-d such as a core 202a-d identifier, used to identify the particular data structure 204a-d storing the identified error record 206a-d, an index in the particular data structure 204a-d storing the identified error record 206a-d, an error code for the corresponding error, and potentially other information. In other embodiments, some other mechanism for generating non-repeating (or sufficiently rarely repeating) identifiers may be used in place of an instance counter.

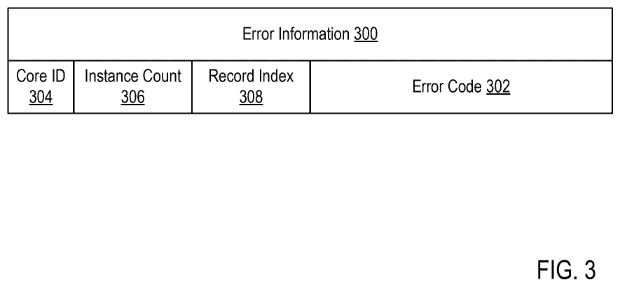

FIG. 3 sets forth an diagram of example error information 300 for efficient error chain logging in a multi-core, asynchronous execution environment in accordance with some embodiments of the present disclosure. In some embodiments, the error information 300 is a value returned by a particular function in a chain of functions to a next-highest-level function in a chain of functions (e.g., to the function that called the particular function). In some embodiments, the error information 300 may be implemented as a 64-bit value, or a value of another size, with each of the shown data points being encoded as a subset of the bits of the error information 300. Readers will appreciate that the particular data points and their ordering as shown in the error information 300 is merely exemplary and that other data points and orderings are contemplated within the scope of the present disclosure.

The error information 300 includes, at its lowest-order bits, an error code 302. The error code 302 is a predefined value corresponding to a particular type of error. Accordingly, a function experiencing a particular type of error may include, in its returned error information 300, the corresponding error code 302. The error information 300 also includes additional information that may be used, independent of or in addition to the error code 302, in identifying and/or referencing an error record. For example, the error information 300 may include a core identifier 304, an instance count 306, and a record index 308. The core identifier 304 serves as an identifier for a particular data structure storing a particular error record. The instance count 306 is the instance count of the particular error record as stored. The record index 308 is the index of the data structure storing the particular error record. As will be described in further detail below when discussing traversing and reading chains of error records, all or a subset of this error information 300 may be used as an error record identifier. Accordingly, when storing an error record that includes an error record identifier referencing another record, that error record identifier may include all or a portion of this error information 300.

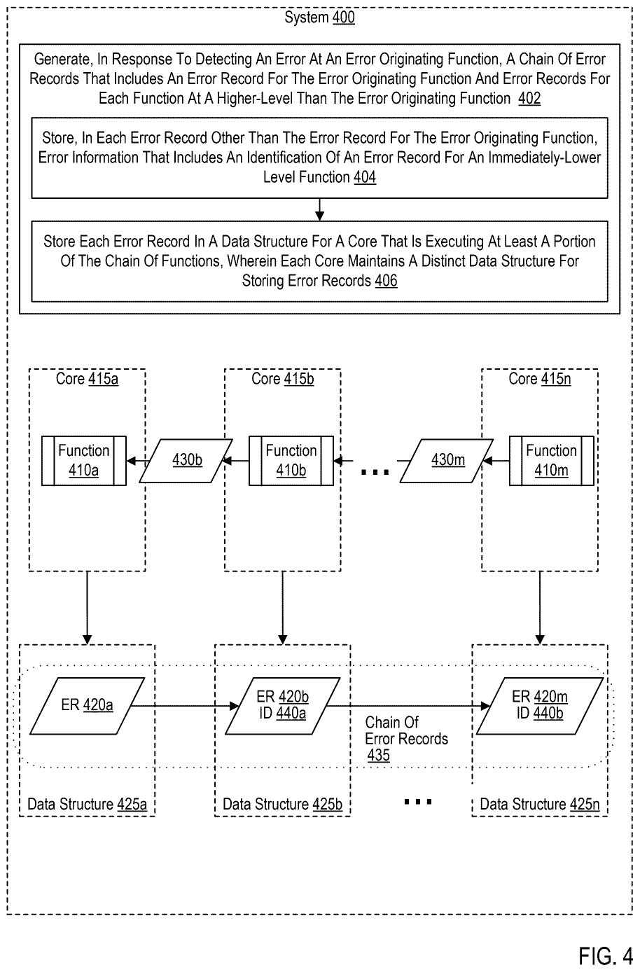

For further explanation, FIG. 4 sets forth a flowchart of an example method of efficient error chain logging in a multi-core, asynchronous execution environment in accordance with some embodiments of the present disclosure. The method of FIG. 4 may be performed, for example, in a system 400 that includes multiple cores 415a,b-n. The multiple cores 415a-n may be included in one or more processing devices such as, for example, one or more CPUs that are part of the system 400. In other embodiments, the multiple cores 415a-n may be included as part of some other processing device that are part of the system 400.

The method of FIG. 4 includes generating 402 a chain 435 of error records in response to detecting an error at an error originating function in a chain of functions. The chain of functions illustrated in FIG. 4 includes function 410a as the highest-level function and function 410m as the lowest-level function. Readers will appreciate that an error can initially occur during the execution of any function that is below the highest-level function 410a in the chain of functions. The function where the error initially occurred is referred to hereafter as the error originating function. For example, if function 102d in FIG. 1 was the first function in the chain of functions to generate an error, function 102d would be the error originating function and functions 102c, 102b, and 102a would all be functions at a higher level than the error originating function. Alternatively, if function 102c in FIG. 1 was the first function in the chain of functions to generate an error, function 102c would be the error originating function and functions 102b and 102a would be functions at a higher level than the error originating function.

In FIG. 4, detecting an error at an error originating function may be carried out, for example, by determining that an error code has been returned by the error originating function, by determining that the error originating function has thrown an exception, by determining that an input validation at the error originating function has not been satisfied, or in some other way. In some embodiments, the error may be detected by the error originating function. For example, if the error occurred in the lowest-level function 410m, detecting an error may be carried out by the lowest-level function 410m itself even though the occurrence of the initial error may cause other higher-level functions 410a, 410b to subsequently experience errors. In other embodiments, the error may be detected by some other process, service, function, or mechanism. For example, an operating system may detect errors, firmware within a processing device that executes at least a portion of the chain of functions may detect the error, and so on.

In FIG. 4, the chain 435 of error records 420a-m includes an error record for the error originating function, as well as error records for each function at a higher-level than the error originating function. Referring again to FIG. 1, if function 102d was the error originating function, the chain of error records would therefore include errors records for each of functions 102d, 102c, 102b, and 102a. Alternatively, if function 102c was the error originating function, the chain of error records would therefore include error records only for functions 102c, 102b, and 102a. In this example, function 102d would not include an error record in the resulting chain of error records since function 102d is at a lower-level than where the error occurred. Readers will appreciate in these examples, a higher-level function calls a lower-level function and a lower-level function must finish executing as a precondition for the higher-level function completing its execution. In other embodiments, designations other than higher-level or lower-level may be utilized.

In FIG. 4, generating 402 a chain 435 of error records 420a-m can include storing 404, in each error record other than the error record for the error originating function, error information that includes an identification 440a-b of an error record for an immediately-lower level function. The error information that includes an identification 440a-b of an error record for an immediately-lower level function may be embodied, for example, as an identifier associated with the error record for an immediately-lower level function, as a pointer to the error record for an immediately-lower level function, or in some other way. Because the error record 420a-m itself may be a predetermined data structure (e.g., a record), storing 404 an identification 440a-b of an error record for an immediately-lower level function may be carried out by writing the identification 440a-b of an error record for an immediately-lower level function to a field in the error record data structure that is used to store such information.

Referring again to FIG. 1, assume that function 102c was the error originating function. In this example, the error record for function 102c would not include an identification of an error record for an immediately-lower level function since function 102d, which is the immediately-lower level function to function 102c, does not have an associated error record. The error record for function 102b and the error record for function 102a, however, would include an identification of an error record for an immediately-lower level function. In this example, the error record for function 102b would include an identification of an error record for function 102c (the immediately-lower level function to function 102b) and the error record for function 102a would include an identification of an error record for function 102b (the immediately-lower level function to function 102a). In FIG. 4, this concept is illustrated as error records 420b-m each include an identification of an error record for an immediately-lower level function. For example, the error record for function 410b includes an identification 440a of an error record 420a for immediately-lower level function 410a and the error record for function 410m includes an identification 440b of an error record 420b for immediately-lower level function 410b. The chain 435 of error records that are generated 402 in FIG. 4 therefore includes error records that, aside from a lowest-level error record, each uniquely references another error record to form a linear chain of error records.

Readers will appreciate that in addition to storing 404 an identification 440a-b of an error record for an immediately-lower level function, generating 402 a chain of error records can include storing additional information in each error record 420a-m. For example, in some embodiments, error records 420a-n can include an error code for the particular error, or error information returned to a particular function (e.g., by a lower-level function), or a timestamp for the particular error, or a function name for the particular function, or a source code file name that includes the particular function, or a source code line number where the particular error occurred, and/or other information including any combination of the above referenced items.

In FIG. 4, generating 402 a chain of error records can also include storing 406 each error record 420a-m in a data structure 425a-n for a core 415a-n that is executing at least a portion of the chain of functions. As described above, each core 415a-n may maintain a distinct data structure 425a-n for storing error records. Each data structure 425a-n that is associated with a particular core 415a-n may be a fixed-size, circular data structure. A particular error record 420a-m may be stored in a particular core's data structure 425a-n, for example, by writing the record to a location in memory of the core that corresponds to a predetermined location in the data structure 425a-n. The predetermined location may be determined as described in greater detail above. For example, an error record may be written to the next entry relative to a pointer in the fixed-size, circular data structure, where the pointer is moved to the next entry once an error record has been successfully written.

In some embodiments, error information 430b, 430m may be returned to a particular function 410a-m in addition to being stored in an error record. Such error information 430b, 430m that is returned to a particular function 410a-m may include an error record identifier for an error record 420a-m that was stored by a lower-level function. For example and referring again to FIG. 1, if function 102d was the error originating function, information passed to function 102c could include an identifier for the stored error record for function 102d, information passed to function 102b could include an identifier for the stored error record for function 102c, and information passed to function 102a could include an identifier for the stored error record for function 102b. Such error record identifiers may even include an identifier for a particular data structure 425a-n that stores the error record as well as an index into the data structure where the error record is stored. Such error recording identifiers may even include an instance count for the error record that may be used to determine whether an error record has been overwritten.

As an example, assume an error occurs during execution in the function 410m. An error record 420m describing this error is generated and stored by core 415n in its corresponding data structure 425n. This error record 420m may include various data describing the error such as an error code, a name of the function 410m, a line in the function 410m where the error occurred, and the like. As the function 410m is a lowest-level function 410m in the chain of functions the error record 420m will not include an error record identifier referencing another error record 420a-m and no error record identifier will be returned to the function 410m.

The function 410m may then return error information 430m to function 410b, where the error information 430m includes an error record identifier for error record 420m. This process is similarly performed up the chain of functions where error information from some lower-level function is returned to the function 410b, causing an error in function 410b. An error record 420b is stored by the core 415b in the corresponding data structure 425b. This error record 420b includes the error information returned to the function 410b.

The function 410b then returns, to the function 410a, error information 430b including an error record identifier for the error record 420b, thereby causing an error in the function 410a. An error record 420a is stored by core 415a in the corresponding data structure 425a that includes an error record identifier for the error record 420b. In some embodiments, the function 410a may provide its own error information (e.g., an error record identifier for the error record 420a) to another processor service for consuming error information. In some embodiments, the function 410a may perform error handling, log data generation, and the like using the chain of error records.

Readers will appreciate that the approaches set forth herein preserve detailed error information for each function a chain of functions, preventing information loss across a chain of functions and resulting in more useful log data, improving the overall user experience and system utility. Moreover, the approaches set forth herein enable preservation of detailed error information without performance degradations caused by passing increasing amounts of error information up a chain of functions, improving overall system performance.

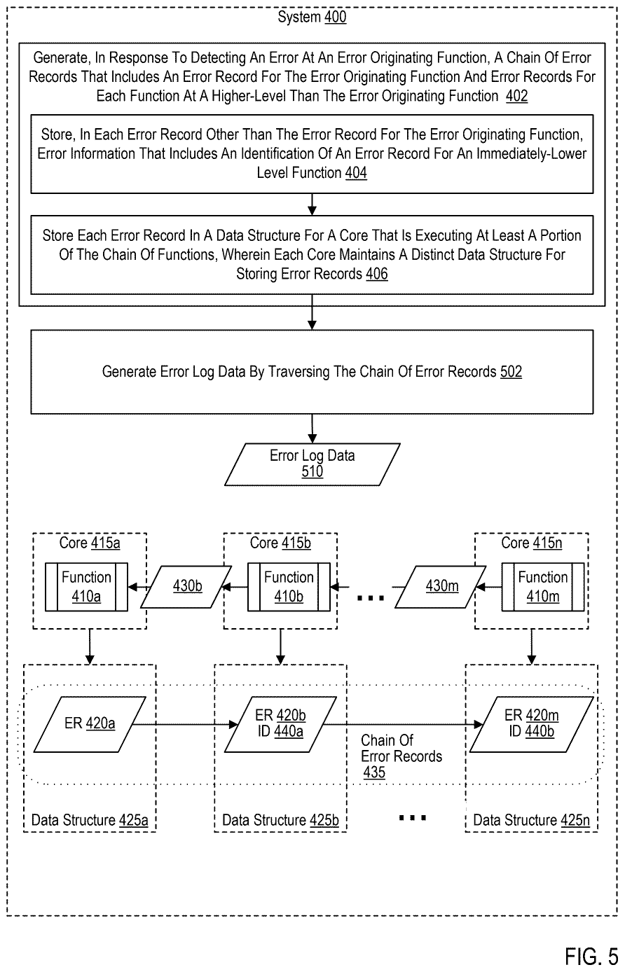

For further explanation, FIG. 5 sets forth a flowchart of an example method of efficient error chain logging in a multi-core, asynchronous execution environment in accordance with some embodiments of the present disclosure. The method of FIG. 5 also includes generating 502 error log data 510 by traversing the chain 435 of error records. The error log data describes the errors experienced in the chain of functions 410a-m by including information accessed from or based on the chain 435 of error records 420a-m. In some embodiments, generating 502 the error log data includes storing the error log data 510 in a file, data structure, and the like. In some embodiments, generating 502 the error log data 510 includes providing the error log data to some remotely disposed computing system. In some embodiments, generating 502 the error log data includes rendering or presenting the error log data in a notification, graphical user interface (GUI) element, command line interface (CLI) or terminal, and the like.

Traversing the chain of error records can include accessing a first error record 420a in the chain 435 of error records. Using the error record identifier in the error record 420a, the next error record 420b in the chain of error records may be accessed. This process of accessing the next error record using the error record identifier stored in the last accessed error record is repeated for each error record 420a-m in the chain of error records until the last error record 420m in the chain of error records is loaded. As each entry in the chain 435 of error records is accessed, the information stored therein may be output or otherwise encoded into the error log data 510.

In some embodiments, the data structures 425a-n may be implemented as circular data structures 425a-n, introducing the possibility that some error record 420a-m included in the chain of error records has been overwritten. Accordingly, in some embodiments, the process of accessing a given error record 420a-m using an error record identifier from a higher-level error record 420a-m may include a verification step to ensure that the loaded error record 420a-m is correct. Should an accessed error record 420a-m fail verification, traversal of the chain of error records may terminate and those loaded error records 420a-m that passed verification may be used to generate 502 the error log data.

For example, in an embodiment assume that error record identifier includes information identifying a core 415a-n whose data structure contains the error record associated with the error record identifier, an index where the error record is stored in the data structure, and an instance count. In some embodiments, the error record 420a-m at the index specified in the error record identifier may be retrieved from the data structure 425a-n corresponding to the identified core 415a-n. In some embodiments, the instance count from the error record identifier may be compared to the instance count of the retrieved error record 420a-m. Where these instance counts match, the retrieved error record 420a-m may be correct. Where these instance counts do not match, this may indicate that the retrieved error record 420a-m referenced by the error record identifier has been overwritten, causing verification to fail.

In some embodiments, should enough error records 420a-m be written to a given data structure 425a-n, the instance count may roll over depending on how many bits are used to encode the instance count. For example, where eight bits are used to implement the instance count, the instance count may have a maximum value of 255. Overwriting an error record 420a-m with an instance count of 255 may cause the instance count to roll over, causing the new error record 420a-m to be stored with an instance count of zero. Given enough errors, it may be possible for an error record 420a-m to match the instance count of an overwritten error record 420a-m. Accordingly, it may be possible for a loaded error record 420a-m to have the same instance count as an error record identifier but nonetheless be the incorrect error record 420a-m.

To address this possibility, in some embodiments, the error record identifier may also include the error code for the corresponding error that is stored in the error record 420a-m. For example, after loading an error record 420a-m from a particular data structure 425a-n at a particular index, both the instance count and the error code of the error record 420a-m may be compared to the instance count and error code in the error record identifier. Where both match, verification passes. Where either value fails to match, verification fails. This results in a significantly improbable chance of a false positive verification.

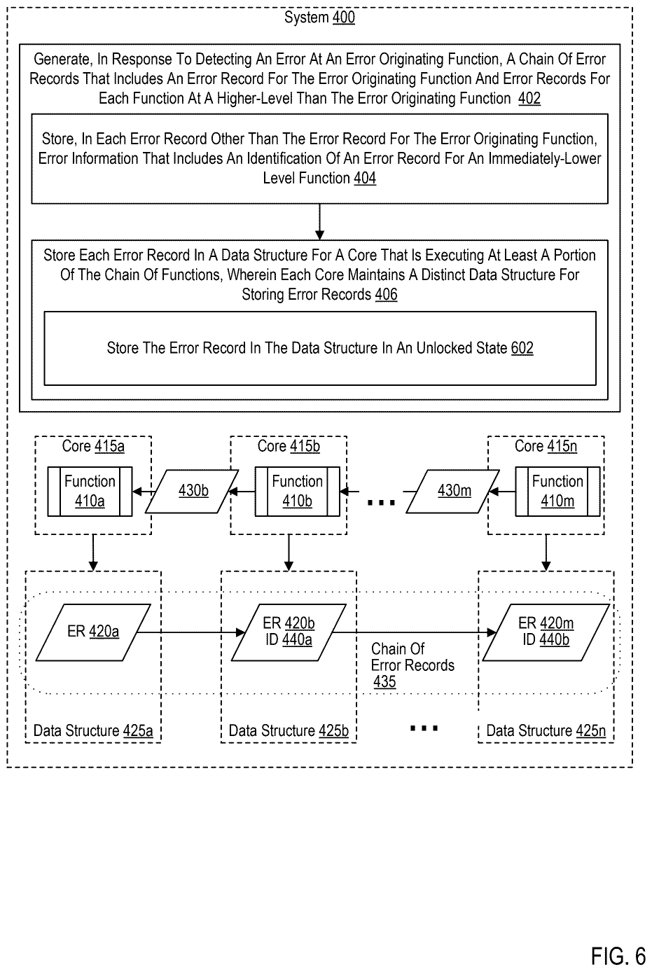

For further explanation, FIG. 6 sets forth a flowchart of an example method of efficient error chain logging in a multi-core, asynchronous execution environment in accordance with some embodiments of the present disclosure. In FIG. 6, storing 406 each error record 420a-m in a data structure 425a-n for a core 415a-n that is executing at least a portion of the chain of functions can include storing 602 the error record 420a-m in the data structure 425a-n in an unlocked state. Locking a region of memory, such as a region of memory in a core where the data structure 425a-n is located, prevents reading from and/or writing to that region of memory by multiple threads of execution. In other words, only the owner of a lock may read from or write to a locked region of memory.

Were a particular core 415a-n to place a lock on a particular data structure 425a-n (by placing a lock on the corresponding memory region), only the particular core 415a-n that manages a particular data structure 425a-n may be able to read from or write to the particular data structure 425a-n. Were it possible for any core 415a-n to read from or write to any other data structure 425a-n locks, would be necessary to prevent a core 415a-n from writing to a region of memory being written to by another core 415a-n. Instead, because in some embodiments each data structure 425a-n corresponds to a particular core 415a-n, each core 415a-n may only write to its corresponding data structure 425a-n and there is no risk of two cores 415a-n writing to the same region of memory (e.g., the same data structure 425a-n). This prevents performance overhead resulting from applying and releasing locks to regions of memory, improving system utility.

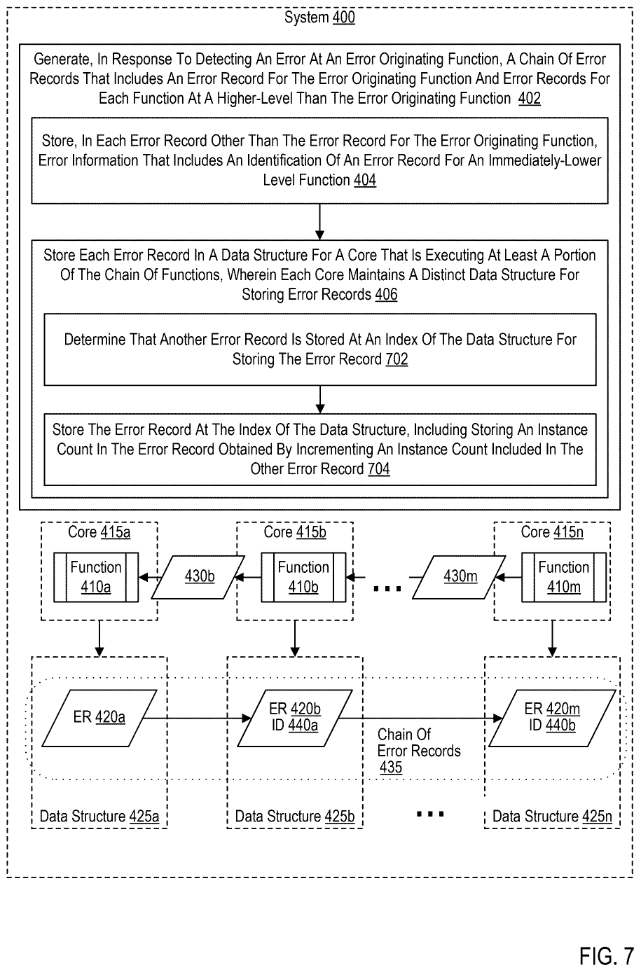

For further explanation, FIG. 7 sets forth a flowchart of an example method of efficient error chain logging in a multi-core, asynchronous execution environment in accordance with some embodiments of the present disclosure. In FIG. 7, storing 406 each error record 420a-m can include determining 702 that another error record 420a-m is stored at an index of the data structure 425a-n for storing the corresponding error record 420a-m. This may include, for example, attempting to load data from the data structure 425a-n at the index and receiving the other error record 420a-m in response. In embodiments where data structures 425a-n are implemented as circular data structures 425a-n, error records 420a-m may be stored into a given data structure 425a-n at incrementally increasing indices. After writing an error record 420a-m to the final index, the next error record 420a-m will be written to the first error record. As the other error record 420a-m is stored at the index to be used by the corresponding error record 420a-m, this other error record 420a-m must be overwritten by the error record 420a-m that is being stored 406.

In FIG. 7, storing 406 each error record 420a-m can also include storing 704 the error record 420a-m at the index of the data structure 425a-n by incrementing an instance count included in the other error record 420a-m. By storing the error record 420a-m with an incremented instance count, attempts to load the other error record 420a-m using the overwritten instance count will fail, preventing the loading of invalid or inapplicable data.

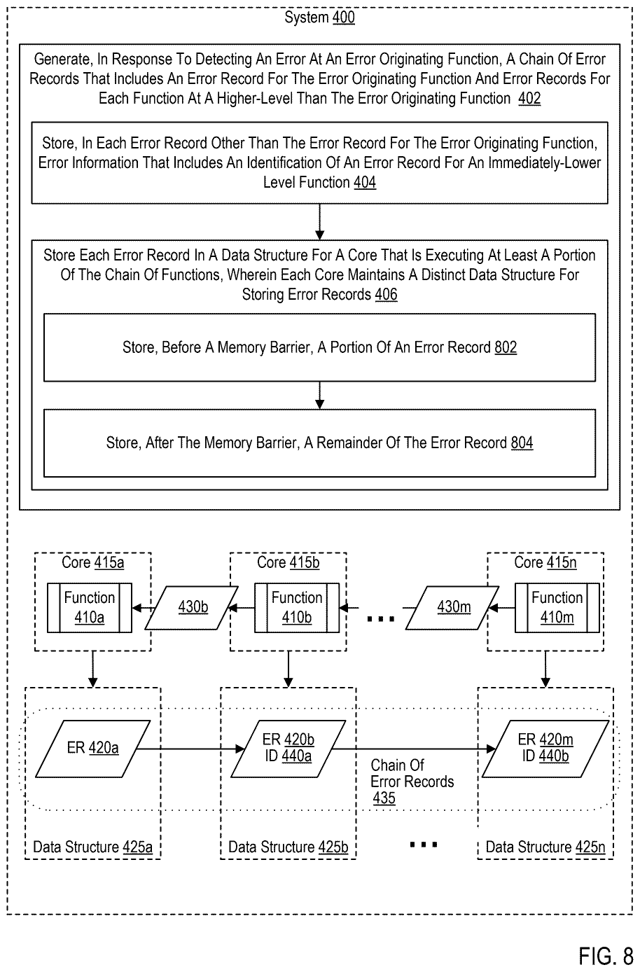

For further explanation, FIG. 8 sets forth a flowchart of an example method of efficient error chain logging in a multi-core, asynchronous execution environment in accordance with some embodiments of the present disclosure. In FIG. 8, storing 406 each error record 420a-m can include storing 802, before a memory barrier, a portion of an error record. For example, storing 406 each error record 420a-m can also include storing 804, after the memory barrier, a remainder of the corresponding error record 420a-m. A memory barrier is a barrier instruction that enforces an ordering constraint on operations issued before the memory barrier and after the memory barrier. In other words, all instructions or operations that occur before a memory barrier must be performed before any of the operations that occur after the memory barrier.

For example, the instance count and error code for the corresponding error record 420a-m may be stored 802 before the memory barrier while a remainder of the error record 420a-m (e.g., information such as a function 410a-m name, a source code line, a source code file name, and the like) is stored after the memory barrier. The instance count and error code may be stored before the memory barrier as these are components of an error record identifier (e.g., in addition to a core 415a-n identifier and index) may be used to uniquely identify and verify a loaded error record 420a-m. As is set forth above, after loading an error record 420a-m, the loaded instance count and error code are compared to those included in the error record identifier. The loaded error record 420a-m may be verified where these compared values both.

Storing 802 the instance count and error code of the corresponding error record 420a-m before the remainder of the corresponding error record 420a-m further enables the storing of error records 420a-m into data structures 425a-n in an unlocked state (e.g., without locking the data structures 425a-n). Consider an example where a given error record 420a-m (hereinafter error record A) is to be stored at some index where another error record 420a-m (hereinafter error record X) is stored. Further assume that error record A has an error code for a page fault and includes a reference (e.g., to another record in a chain of error records) to error record B while error record X has an instance count of six, an error code for a CRC mismatch, and a reference to error record Y.

In this example, assume that, to overwrite error record X with error record A, the reference to error record B is stored first, overwriting the reference to error record Y. Before any of the other information of error record A can be written, the data at this index is read as part of a traversal of a chain of error records. The loaded data includes an instance count and error code that matches the error record identifier for error record X as these values have not yet been overwritten. Accordingly, this loaded data will pass validation. However, this loaded data includes an incorrect reference to error record B instead of the correct reference to error record Y. This may cause the incorrect error record B to be loaded to continue the traversal of the chain of error records, causing any subsequently loaded records to also be incorrect. Here, a memory lock applied before writing error record A would have prevented any data from being loaded until writing error record A was complete, preventing the introduction of incorrect information into the traversal of the chain of error records.

Instead, assume that the memory barrier is included after the instance count and the error code. Accordingly, the instance count (e.g., seven) and error code for error record A overwrite those of error record X before any other data. Assume that data is read from this index using the error record identifier for error record X before the reference to error record Y can be overwritten with the reference to error record B. Here, the loaded data will include an instance count and error code that does not match those included in the error record identifier for error record B, causing validation to fail and preventing access to additional incorrect information. The use of a memory barrier ensures that information used to identify and validate error records is written first, causing partially overwritten error records to fail validation, eliminating the need to apply a memory lock. This saves on the computational and resource overhead required when applying and releasing memory locks. Moreover, this allows for processes that may access these error records to continue execution without waiting for a lock to be released.

In the examples set forth above, the instance count and error code were stored before the memory barrier as these values are used in validating loaded error records 420a-m. Readers will appreciate that, in some embodiments, both of these values may not be used when validating loaded error records 420a-m. For example, in some embodiments, a loaded error record 420a-m may be validated using only the instance count. Accordingly, in such embodiments, only the instance count may be stored before the memory barrier while a remainder of the error record 420a-m may be stored after the memory barrier. In other words, in some embodiments, any information used to validate an error record 420a-m may be stored before a memory barrier and the remainder stored after the memory barrier.

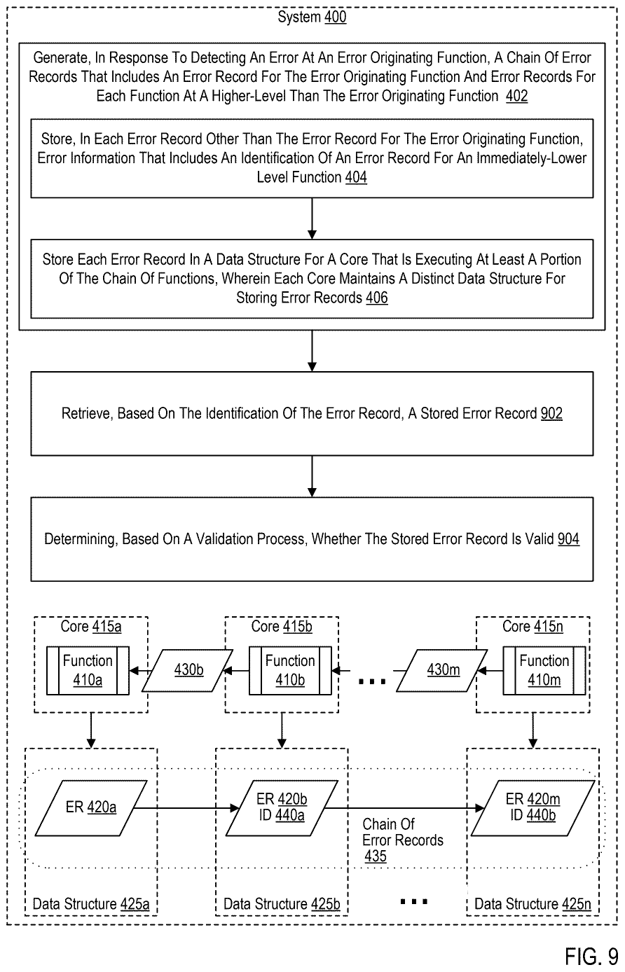

For further explanation, FIG. 9 sets forth a flowchart of an example method of efficient error chain logging in a multi-core, asynchronous execution environment in accordance with some embodiments of the present disclosure. The example in FIG. 9 includes retrieving 902, based on the identification of the error record, a stored error record and determining 904, based on a validation process, whether the stored error record is valid. In this example, such validation processes can include validation processes that examine an instance count to verify that a retrieved error record is the expected error record. Other information may also be examined during validation, as described above.

Although some embodiments are described above in which the steps of storing 404 error information in error records and storing 406 each error record in a data structure are included as part of generating 402 a chain of error records, other embodiments exist in the scope of the present disclosure. For example, one or more of the storing 404, 406 steps may be carried out separately from generating 402 a chain of error records. Likewise, in some embodiments only one of the storing 404, 406 steps may be carried out.

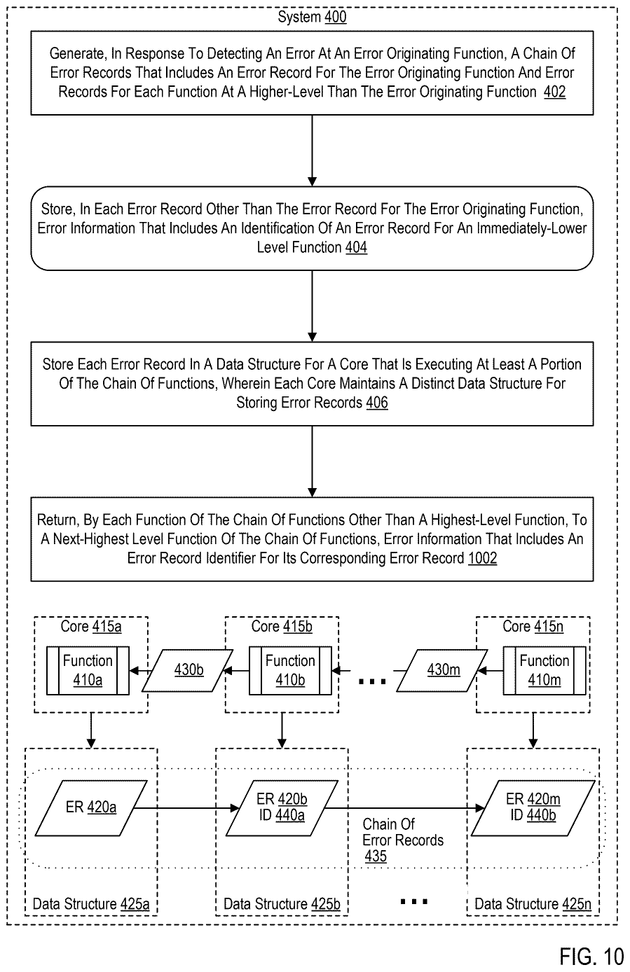

As an example of an embodiment where some of the steps are arranged differently as described in the preceding paragraph, FIG. 10 sets forth a flowchart of an additional example method of efficient error chain logging in a multi-core, asynchronous execution environment in accordance with some embodiments of the present disclosure that differs from some previous examples. The example of FIG. 10 depicts an embodiment that includes generating 402 a chain 435 of error records in response to detecting an error at an error originating function in a chain of functions, as described above. The example depicted in FIG. 10 also includes storing 406 each error record 420a-m in a data structure 425a-n for a core 415a-n that is executing at least a portion of the chain of functions, which may be carried out as described in greater detail above. In FIG. 10, the method may optionally include storing 404, in each error record other than the error record for the error originating function, error information that includes an identification 440a-b of an error record for an immediately-lower level function, which may be carried out as described in greater detail above.

The example in FIG. 10 also includes returning 1002, by each function 410b-m of the chain of functions other than a highest-level function 410a, to a next-highest level function of the chain of functions, error information 430b-m that includes an error record identifier for its corresponding error record. Such error information 430b, 430m that is returned to a particular function 410a-m may include an error record identifier for an error record 420a-m that was stored by a lower-level function. Returning 1002 error information 430b-m that includes an error record identifier for its corresponding error record may be carried out, for example, by including such information in a return from a call to the function that was initiated by the higher-level function.

As an example, assume an error occurs during execution in the function 410m. An error record 420m describing this error is generated and stored by core 415n in its corresponding data structure 425n. This error record 420m may include various data describing the error such as an error code, a name of the function 410m, a line in the function 410m where the error occurred, and the like. As the function 410m is a lowest-level function 410m in the chain of functions the error record 420m will not include an error record identifier referencing another error record 420a-m and no error record identifier will be returned to the function 410m.

The function 410m may then return error information 430m to function 410b, where the error information 430m includes an error record identifier for error record 420m. This process is similarly performed up the chain of functions where error information from some lower-level function is returned to the function 410b, causing an error in the function 410b. An error record 420b is stored by the core 415b in the corresponding data structure 425b. This error record 420b includes the error information returned to the function 410b.

The function 410b then returns, to the function 410a, error information 430b including an error record identifier for the error record 420b, thereby causing an error in the function 410a. An error record 420a is stored by core 415a in the corresponding data structure 425a that includes an error record identifier for the error record 420b. In some embodiments, the function 410a may provide its own error information (e.g., an error record identifier for the error record 420a) to another processor service for consuming error information. In some embodiments, the function 410a may perform error handling, log data generation, and the like using the chain of error records.

Readers will appreciate that the approaches set forth herein preserve detailed error information for each function a chain of functions, preventing information loss across a chain of functions and resulting in more useful log data, improving the overall user experience and system utility. Moreover, the approaches set forth herein enable preservation of detailed error information without performance degradations caused by passing increasing amounts of error information up a chain of functions, improving overall system performance.

Readers will appreciate that, although the approaches set forth herein describe storing error records in data structures each corresponding to a different core, this was done to ensure that each data structure may be written to without the need to apply a memory lock. Accordingly, the approaches set forth above may also be applicable to other allocations or degrees of granularity used when allocating data structures for exclusive write access. For example, data structures may be assigned to particular processor packages, threads, or any execution unit as long as the particular allocation used allows for writes of error records without the need for memory locks on the data structures.

Additionally, although the approaches set forth herein describe the creation of error records for each function of a chain of functions, the approaches set forth herein may also be applied to other related sets of operations. For example, in some embodiments, the approaches set forth herein may be applied to related, asynchronous operations, with error records being stored for each related operation.

Moreover, the approaches set forth herein are presented in the context of a single system or computing device having multiple cores. In some embodiments, the approaches set forth herein may also be applied to clusters or groupings of multiple, intercommunicating computing devices. In such embodiments, an error record and/or an error record identifier may require additional information such as machine identifiers, node identifiers, cluster identifiers, and the like. Particularly, this additional information may be required such that a chain of error records may be traversed across these multiple machines or devices in a linear fashion (e.g., without additional correlation). Accordingly, readers will appreciate that the particular scope of an error record identifier may be variable across implementations so as to enable a linear traversal of a chain of error records.

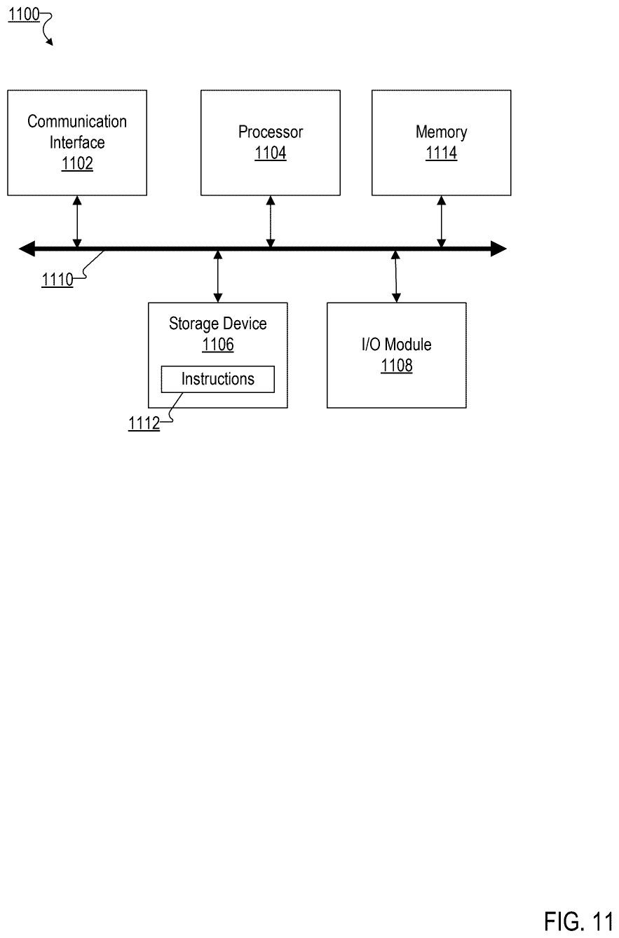

To illustrate examples of technologies that may be used to implement the approaches set forth herein, FIG. 11 illustrates an exemplary computing device 1100 that may be specifically configured to perform one or more of the processes described herein. As shown in FIG. 11, computing device 1100 may include a communication interface 1102, a processor 1104, a storage device 1106, an input/output (I/O) module 1108, and computer memory 1114 communicatively connected one to another via a communication infrastructure 1110. While an exemplary computing device 1100 is shown in FIG. 11, the components illustrated in FIG. 11 are not intended to be limiting. Additional or alternative components may be used in other embodiments. Components of computing device 1100 shown in FIG. 11 will now be described in additional detail.

Communication interface 1102 may be configured to communicate with one or more computing devices. Examples of communication interface 1102 include, without limitation, a wired network interface (such as a network interface card), a wireless network interface (such as a wireless network interface card), a modem, an audio/video connection, and any other suitable interface.

Processor 1104 generally represents any type or form of processing unit capable of processing data and/or interpreting, executing, and/or directing execution of one or more of the instructions, processes, and/or operations described herein. Processor 1104 may perform operations by executing computer-executable instructions 1112 (e.g., an application, software, code, and/or other executable data instance) stored in storage device 1106. Although not explicitly illustrated in FIG. 11, processor 1104 can include multiple cores. Each core may be embodied, as an distinct processing unit that may independently execute instructions, meaning that the processor 1104 can process data and run tasks in parallel.

Storage device 1106 may include one or more data storage media, devices, or configurations and may employ any type, form, and combination of data storage media and/or device. For example, storage device 1106 may include, but is not limited to, any combination of non-volatile media and/or volatile media. Electronic data, including data described herein, may be temporarily and/or permanently stored in storage device 1106. For example, data representative of computer-executable instructions 1112 configured to direct processor 1104 to perform any of the operations described herein may be stored within storage device 1106. In some examples, data may be arranged in one or more databases residing within storage device 1106.

I/O module 1108 may include one or more I/O modules configured to receive user input and provide user output. I/O module 1108 may include any hardware, firmware, software, or combination thereof supportive of input and output capabilities. For example, I/O module 1108 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1108 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 1100.

Advantages and features of the present disclosure can be further described by the following statements:
1. A method of efficient error chain logging in a multi-core, asynchronous execution environment, comprising: generating, in response to detecting an error at an error originating function in a chain of functions, a chain of error records that includes an error record for the error originating function and error records for each function at a higher-level than the error originating function, including: storing, in each error record other than the error record for the error originating function, error information that includes an identification of an error record for an immediately-lower level function; and storing each error record in a data structure for a core that is executing at least a portion of the chain of functions, wherein each core maintains a distinct data structure for storing error records.
2. The method of statement 1, further comprising generating error log data by traversing the chain of error records.
3. The method of statements 1 or 2, wherein the plurality of data structures comprises a plurality of fixed-size, circular data structures.
4. The method of any of statements 1-3, further comprising returning, by each function of the chain of functions other than a highest-level function, to a next-highest level function of the chain of functions, error information that includes an error record identifier for its corresponding error record.
5. The method of any of statements 1-4, wherein storing the error record includes: determining that another error record is stored at an index of the data structure for storing the error record; and storing the error record at the index of the data structure, including storing an instance count in the error record obtained by incrementing an instance count included in the other error record.
6. The method of any of statements 1-5, wherein further comprising: retrieving, based on the identification of the error record, a stored error record; and determining, based on a validation process, whether the stored error record is valid.
7. The method of any of statements 1-6, wherein storing each error record in the data structure for the core includes storing the error record in the data structure in an unlocked state.
8. The method of any of statements 1-7 wherein storing the error record includes: storing, before a memory barrier, a portion of an error record; and storing, after the memory barrier, a remainder of the error record.
9. An apparatus for efficient error chain logging in a multi-core, asynchronous execution environment, comprising: a memory; and one or more processing devices, operatively coupled to the memory, the one or more processing devices configured to: generate, in response to detecting an error at an error originating function in a chain of functions, a chain of error records that includes an error record for the error originating function and error records for each function at a higher-level than the error originating function; store each error record in a data structure for a core that is executing at least a portion of the chain of functions, wherein each core maintains a distinct data structure for storing error records; and return, by each function of the chain of functions other than a highest-level function, to a next-highest level function of the chain of functions, error information that includes an error record identifier for its corresponding error record.
10. The apparatus of statement 9, wherein the one or more processing devices are further configured to generate error log data by traversing the chain of error records.
11. The apparatus of statements 9 or 10, wherein the plurality of data structures comprises a plurality of circular data structures.
12. The apparatus of any of statements 9-11, wherein the one or more processing devices are further configured to store, in each error record other than the error record for the error originating function, error information that includes an identification of an error record for an immediately-lower level function.
13. The apparatus of any of statements 9-12, wherein the one or more processing devices are further configured to: retrieve, based on the identification of the error record, a stored error record; and determine, based on a validation process, whether the stored error record is valid.
14. The apparatus of any of statements 9-13, wherein each error record is stored in the data structure in an unlocked state.
15. A non-transitory computer readable storage medium storing instructions which, when executed, cause a processing device to: generate, in response to detecting an error at an error originating function in a chain of functions, a chain of error records that includes an error record for the error originating function and error records for each function at a higher-level than the error originating function; store, in each error record other than the error record for the error originating function, error information that includes an identification of an error record for an immediately-lower level function; and store each error record in a data structure for an execution unit that is executing at least a portion of the chain of functions, wherein each execution unit maintains a distinct data structure for storing error records.
16. The non-transitory computer readable storage medium of statement 15, wherein the instructions, when executed, further cause the processing device to generate error log data by traversing the chain of error records.
17. The non-transitory computer readable storage medium of statements 15 or 16, wherein the plurality of data structures comprises a plurality of circular data structures.
18. The non-transitory computer readable storage medium of any of statements 15-17, wherein the instructions, when executed, further cause the processing device to return, by each function of the chain of functions other than a highest-level function, to a next-highest level function of the chain of functions, error information that includes an error record identifier for its corresponding error record.
19. The non-transitory computer readable storage medium of any of statements 15-18, wherein the instructions, when executed, further cause the processing device to: retrieve, based on the identification of the error record, a stored error record; and determine, based on a validation process, whether the stored error record is valid.
20. The non-transitory computer readable storage medium of any of statements 15-19, wherein to store each error record in the data structure for the execution unit, the instructions, when executed, further cause the processing device to store the error record in the data structure in an unlocked state.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more Azure Virtual Machines), in one or more containers, in one or more cloud computing instances (e.g., one or more AWS EC2™ instances, one or more Azure Functions™), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method of efficient error chain logging in a multi-core, asynchronous execution environment, comprising:
generating, in response to detecting an error at an error originating function in a chain of functions, a chain of error records that includes an error record for the error originating function and error records for each function at a higher-level than the error originating function, including:
storing, in each error record other than the error record for the error originating function, error information that includes an identification of an error record for an immediately-lower level function; and
storing each error record in a data structure for a core that is executing at least a portion of the chain of functions, wherein each core maintains a distinct data structure for storing error records.

2. The method of claim 1, further comprising generating error log data by traversing the chain of error records.

3. The method of claim 1, wherein each data structure comprises a fixed-size, circular data structure.

4. The method of claim 1 further comprising returning, by each function of the chain of functions other than a highest-level function, to a next-highest level function of the chain of functions, error information that includes an error record identifier for its corresponding error record.

5. The method of claim 1 wherein storing the error record includes:
determining that another error record is stored at an index of the data structure for storing the error record; and
storing the error record at the index of the data structure, including storing an instance count in the error record obtained by incrementing an instance count included in the other error record.

6. The method of claim 1 further comprising:
retrieving, based on the identification of the error record, a stored error record; and
determining, based on a validation process, whether the stored error record is valid.

7. The method of claim 1, wherein storing each error record in the data structure for the core includes storing the error record in the data structure in an unlocked state.

8. The method of claim 1, wherein storing the error record includes:
storing, before a memory barrier, a portion of an error record; and
storing, after the memory barrier, a remainder of the error record.

9. An apparatus for efficient error chain logging in a multi-core, asynchronous execution environment, comprising:
a memory; and
one or more processing devices, operatively coupled to the memory, the one or more processing devices configured to:
generate, in response to detecting an error at an error originating function in a chain of functions, a chain of error records that includes an error record for the error originating function and error records for each function at a higher-level than the error originating function;
store each error record in a data structure for a core that is executing at least a portion of the chain of functions, wherein each core maintains a distinct data structure for storing error records; and
return, by each function of the chain of functions other than a highest-level function, to a next-highest level function of the chain of functions, error information that includes an error record identifier for its corresponding error record.

10. The apparatus of claim 9, wherein the one or more processing devices are further configured to generate error log data by traversing the chain of error records.

11. The apparatus of claim 9, wherein one or more of the data structures comprises a circular data structure.

12. The apparatus of claim 9, wherein the one or more processing devices are further configured to store, in each error record other than the error record for the error originating function, error information that includes an identification of an error record for an immediately-lower level function.

13. The apparatus of claim 12, wherein the one or more processing devices are further configured to:
retrieve, based on the identification of the error record, a stored error record; and
determine, based on a validation process, whether the stored error record is valid.

14. The apparatus of claim 9, wherein each error record is stored in the data structure in an unlocked state.

15. A non-transitory computer readable storage medium storing instructions which, when executed, cause a processing device to:
generate, in response to detecting an error at an error originating function in a chain of functions, a chain of error records that includes an error record for the error originating function and error records for each function at a higher-level than the error originating function;
store, in each error record other than the error record for the error originating function, error information that includes an identification of an error record for an immediately-lower level function; and
store each error record in a data structure for an execution unit that is executing at least a portion of the chain of functions, wherein each execution unit maintains a distinct data structure for storing error records.

16. The non-transitory computer readable storage medium of claim 15, wherein the instructions, when executed, further cause the processing device to generate error log data by traversing the chain of error records.

17. The non-transitory computer readable storage medium of claim 15, wherein each data structures comprises a circular data structures.

18. The non-transitory computer readable storage medium of claim 15, wherein the instructions, when executed, further cause the processing device to return, by each function of the chain of functions other than a highest-level function, to a next-highest level function of the chain of functions, error information that includes an error record identifier for its corresponding error record.

19. The non-transitory computer readable storage medium of claim 15, wherein the instructions, when executed, further cause the processing device to:
retrieve, based on the identification of the error record, a stored error record; and
determine, based on a validation process, whether the stored error record is valid.

20. The non-transitory computer readable storage medium of claim 15, wherein to store each error record in the data structure for the execution unit, the instructions, when executed, further cause the processing device to store the error record in the data structure in an unlocked state.
